(19) United States
(12) Patent Application Publication
(10) Pub. No.: US 2025/0295995 A1
(43) Pub. Date: Sep. 25, 2025

(54) RECORDING MEDIUM AND INFORMATION PROCESSING DEVICE THAT TRAIN GAME CONTENTS

(71) Applicant: SEGA CORPORATION, Tokyo (JP)

(72) Inventor: Takahiro Otomo, Tokyo (JP)

(73) Assignee: SEGA CORPORATION, Tokyo (JP)

(21) Appl. No.: 19/227,861

(22) Filed: Jun. 4, 2025

Related U.S. Application Data
(63) Continuation of application No. PCT/JP2023/037942, filed on Oct. 19, 2023.

(30) Foreign Application Priority Data
Dec. 12, 2022 (JP) 2022-197859
Dec. 12, 2022 (JP) 2022-197860
Dec. 12, 2022 (JP) 2022-197861
Dec. 12, 2022 (JP) 2022-197862

(51) Int. Cl. A63F 13/533; A63F 13/69; A63F 13/79; A63F 13/825

(52) U.S. Cl. CPC A63F 13/533; A63F 13/69; A63F 13/79; A63F 13/825

(57) ABSTRACT

A computer-readable non-transitory recording medium records instructions causing a computer to: in response to an input via a terminal device, setting a training game content; displaying a training screen; in response to a player request input via the training screen, increasing a predetermined parameter of the training game; extracting a predetermined number of owned game contents in descending order of a predetermined parameter of the owned game contents; identifying, as a reference game content, the game content having a lowest predetermined parameter; setting, as a set game content, some or all of the owned game contents that have not been extracted; matching the predetermined parameter of the set game content with those of the reference game content; and once the reference game content is changed to another game content in association with an increase in the predetermined parameter of the owned game content, displaying change information.

### CROSS-REFERENCE OF RELATED APPLICATIONS

The present application claims the benefit of priority from JP 2022-197859 filed on Dec. 12, 2022, JP 2022-197860 filed on Dec. 12, 2022, JP 2022-197861 filed on Dec. 12, 2022, and JP 2022-197862 filed on Dec. 12, 2022, the entire disclosures of which are incorporated herein by reference.

### BACKGROUND

### Technical Field

The present invention relates to a recording medium and an information processing device.

### Description of Related Art

Conventionally, games have been known in which a player trains a game content (for example, a character, an item, or the like) that the player owns. This training may involve, for example, increasing a predetermined parameter (for example, level) of the game content (owned game content) that the player owns.

In this regard, patent document 1 discloses art for collectively combining groups of owned game content that are of the same type, thereby reducing the effort required of the player in terms of training.

### Patent Documents

Patent Document 1: JP 6891987

### Technological Problem to Be Solved by Invention

In such games, in order to reduce steps required to train a game content, it is conceivable to set a game content among owned game contents whose predetermined parameters have a specified ranking (for example, third) as a reference game content, and to match the predetermined parameters of another game content (set game content) with the predetermined parameters (reference parameters) of the reference game content. However, the ranking of a predetermined parameter within owned game contents varies depending on game play, and thus there is a problem in that it is difficult for the player to recognize the reference game content. Since the ranking of parameters changes depending on game play, it is difficult to determine and present the reference game content to the player.

Furthermore, in such games, in order to reduce the steps required to train the game content, it is conceivable to set a game content among owned contents whose predetermined parameters have a specified ranking (for example, third) as a reference game content, and to match the predetermined parameters of a set game content set in advance in a setting screen with the predetermined parameters (reference parameters) of the reference game content. However, when a player wants to directly train the set game content, the player must first clear the setting of the set game content on the setting screen and then move to the training screen, which is time-consuming.

Furthermore, in such games, in order to reduce the steps required to train a game content, it is conceivable to set a game content among owned game contents whose predetermined parameters have a specified ranking (for example, third) as the reference game content, and to match the predetermined parameters of the set game content set in advance in a setting screen with the predetermined parameters (reference parameters) of the reference game content. However, when a player wanted to increase a predetermined parameter of the reference game content and thus the predetermined parameter matched a predetermined parameter of the set game content, the player had to check the reference game content on the setting screen, search for the reference game content in an owned character list screen, and designate the reference game content on the training screen.

### SUMMARY

One or more embodiments of the present invention provide, in an information processing device that assists a player to train a game content, a specific algorithm to identify and present a reference game content that serves as a basis for predetermined parameters for training the game content.

Another object is to provide a recording medium and an information processing device that can reduce the effort required for a player to directly train a set game content.

A further object is to provide a recording medium and an information processing device that can reduce the effort required for a player to train the reference game content.

According to a first aspect of the present invention, a non-transitory computer-readable recording medium records instructions for assisting a player to train a game content the instructions causing a computer to execute: in response to an input by a player via a terminal device, setting, as a training game content from among player's owned game contents, an owned game content that has been designated by the player; causing the terminal device to display a training screen including an image showing the training game content; in response to a player request to train the training game content input via the training screen, increasing a predetermined parameter of the training game for training the game content; extracting, from among the owned game contents including the training game content, a predetermined number of owned game contents in descending order of a predetermined parameter of the owned game contents for training the game content; identifying, as a reference game content from among the owned game contents that have been extracted, the game content having a lowest predetermined parameter; setting, as a set game content, some or all of the owned game contents that have not been extracted; matching the predetermined parameter of the set game content with the predetermined parameter of the reference game content; and in response to the reference game content being changed to another game content in association with an increase in the predetermined parameter of the owned game content, displaying change information indicating that the reference game content has been changed to the other content different from the reference game content that has been changed.

Furthermore, in a second aspect of the present invention, the change information includes a name or an image of the other game content different from the reference game content that has been changed.

Furthermore, in a third aspect of the present invention, the change information includes the predetermined parameter of the other game content different from the reference game content that has been changed.

Furthermore, in a fourth aspect of the present invention, the instructions further cause the computer to execute: setting, as a training game content from among the owned game contents, an owned game content that has been designated via a terminal device by the player, displaying a training screen including an image showing the training game content, and in response to receiving a player request from the terminal device to train the training game content, increasing the predetermined parameter of the training game content shown in the image displayed on the training screen, and the displaying includes: in response to the reference game content being changed to the other game content as a result of increasing the predetermined parameter of the training game content, displaying the change information on the training screen.

Furthermore, in a fifth aspect of the present invention, when the predetermined parameter of the reference game content is increased, as the training game content, the change information includes a query as to whether to switch the training game content to the other game content different from the reference game content that has been changed, and the instructions further cause the computer to execute: in response to receiving a player request from the terminal device, switching the training game content to the other game content different from the reference game content that has been changed.

Furthermore, in a sixth aspect of the present invention, when the predetermined parameter of the reference game content is increased, as the training game content, the change information indicates that the training game content is changed to the other game content different from the reference game content that has been changed.

Furthermore, in a seventh aspect of the present invention, the instructions further cause the computer to execute: consuming a cost associated with the player when increasing the predetermined parameter of the training game content.

Furthermore, in an eighth aspect of the present invention, the instructions further cause the computer to execute: refraining from consuming the cost when matching the predetermined parameter of the set game content with the predetermined parameter of the reference game content.

Furthermore, according to a tenth aspect of the present invention, a computer-readable non-transitory recording medium records instructions for assisting a player to train a game content, the instructions causing a computer to execute: extracting a predetermined number of owned game contents in order of highest predetermined parameter, identifying, as a reference game content from among the extracted game contents, the game content with the lowest predetermined parameter, setting, as a set game content, some or all of the owned game contents that have not been extracted, matching the predetermined parameter of the set game content with the predetermined parameter of the reference game content, setting, as the training game content from among the owned game contents, a game content that has been designated via a terminal device by the player, and switching the training game content to the reference game content based on designation of the set game content as the training game content.

Furthermore, in an eleventh aspect of the present invention, the instructions further cause the computer to execute: when the set game content is designated as the training game content, making a query as to whether to switch the training game content to the reference game content, and when, in response to the query, the player requests the switching, switching the training game content to the reference game content.

Furthermore, in a twelfth aspect of the present invention, the instructions further cause the computer to execute: when, in response to the query, the player requests not to switch, clearing the setting of the training game content, and displaying a training screen including an image showing the training game content whose setting has been cleared.

Furthermore, in a thirteenth aspect of the present invention, the instructions further cause the computer to execute: when a set game content is designated as the training game content, receiving an instruction via the terminal device from the player concerned to switch the training game content to the reference game content on the training screen that includes an image showing the training game content, and switching the game content to the standard game content in response to the switching instruction.

Furthermore, in a fourteenth aspect of the present invention, the instructions further cause the computer to execute: consuming a cost associated with the player when increasing the predetermined parameter of the training game content.

Furthermore, in a fifteenth aspect of the present invention, the instructions further cause the computer to execute: refraining from consuming the cost when matching the predetermined parameter of the set game content with the predetermined parameter of the reference game content.

Furthermore, according to a twentieth aspect of the present invention, a computer-readable non-transitory recording medium records instructions for assisting a player to train a game content, the instructions causing a computer to execute: extracting a predetermined number of owned game contents in order of highest predetermined parameter, identifying, as a reference game content from the extracted game content, the game content with the lowest predetermined parameter, setting, as a set game content, some or all of the owned game contents that have not been extracted, due to a request by the player, matching the predetermined parameter of the set game content with the predetermined parameter of the reference game content, setting, as the training game content from among the owned game contents, a game content designated via a terminal device by the player, and clearing the setting of the set game content based on designation of the set game content as the training game content.

Furthermore, in a twenty-first aspect of the present invention, the instructions further cause the computer to execute: when the set game content is designated as the training game content, the control unit inquires of the player as to whether to cancel the setting of the training game content, and when the player requests to cancel the setting in response to the query, the setting unit clears the setting of the training game content.

Furthermore, in a twenty-second aspect of the present invention, the instructions further cause the computer to execute: when the player requests not to cancel the training game content in response to the query, switching the training game content to the reference game content.

Furthermore, in a twenty-third aspect of the present invention, the instructions further cause the computer to execute: when the set game content is designated as the training game content, accepting an instruction from the player to cancel the setting of the training game content on a training screen including an image showing the training game content, and clearing the setting of the training game content in response to the instruction to cancel.

Furthermore, in a twenty-fourth aspect of the present invention, the instructions further cause the computer to execute: consuming the cost associated with the player when increasing the predetermined parameters of the training game content.

Furthermore, in a twenty-fifth aspect of the present invention, the instructions further cause the computer to execute: refraining from consuming the cost when matching the predetermined parameters of the set game content with the predetermined parameters of the reference game content.

Furthermore, the recording medium according to a thirtieth aspect of the present invention is a computer-readable non-transitory recording medium for recording instructions, that cause a computer to execute: extracting, from among player's owned game contents, a predetermined number of owned game contents in descending order of a predetermined parameter, identifying, as a reference game content from the extracted game contents, the game content having the lowest predetermined parameter, setting, as set game content, some or all of the owned game contents that have not been extracted, matching the predetermined parameter of the set game content with the predetermined parameter of the reference game content, and providing an instruction area for increasing a predetermined parameter of the reference game content on a setting screen on which the player sets the set game content.

Furthermore, in a thirty-first aspect of the present invention, the instructions further cause the computer to execute: based on the fact that the reference game content has been changed to other game content due to an increase in a predetermined parameter of the reference game content, displaying change information indicating the change.

Furthermore, in a thirty-second aspect of the present invention, the change information includes the name or image of other game content that has been changed.

Furthermore, in a thirty-third aspect of the present invention, the change information includes the predetermined parameters of other game content that has been changed.

Furthermore, in a thirty-fourth aspect of the present invention, the instructions further cause the computer to execute: consuming the cost associated with the player when increasing the predetermined parameter of the reference game content.

Furthermore, in a thirty-fifth aspect of the present invention, the instructions further cause the computer to execute: refraining from consuming the cost when matching the predetermined parameters of the set game content with the predetermined parameters of the reference game content.

According to the present invention, it is possible to allow a player to easily recognize reference game content that serves as a reference for a predetermined parameter. Furthermore, according to the present invention, it is possible to reduce the effort required for the player to directly train set game content. Furthermore, according to the present invention it is possible to reduce the time and effort required for players to train reference game content.

### BRIEF DESCRIPTION OF DRAWINGS

FIG. 1 is a block diagram illustrating an example of the overall configuration of the game system according to a first embodiment.

FIG. 2 is a diagram illustrating an example of a hardware configuration of a server device.

FIG. 3 is a diagram illustrating an example of a hardware configuration of a smartphone as the terminal device illustrated in FIG. 1.

FIG. 4 is a block diagram illustrating an example of a functional unit of a server device.

FIG. 5 is a flowchart illustrating an example of a process flow for displaying change information indicating that a reference character has been changed in the game system according to the first embodiment.

FIG. 6 is a diagram illustrating an example of a training screen including an image showing a training character.

FIG. 7 is a diagram illustrating an example of a training screen including change information.

FIG. 8 is a diagram illustrating an example of a training screen in the case where training is continued without switching training characters.

FIG. 9 is a diagram illustrating an example of a training screen in which a training character has been switched to a reference character.

FIG. 10 is a flowchart illustrating an example of a process flow for switching a training character to a reference character in a game system according to a second embodiment.

FIG. 11 is a diagram illustrating an example of an owned character list screen for designating a training character.

FIG. 12 is a diagram illustrating an example of an owned character list screen including a query as to whether to switch the training character.

FIG. 13 illustrates an example of a training screen with the training character switched to the reference character.

FIG. 14 is a flowchart illustrating an example of the process flow for clearing the setting of a training character in the game system for a third embodiment.

FIG. 15 is a diagram illustrating an example of an owned character list screen including a query as to whether to cancel the setting.

FIG. 16 is a illustrating an example of a training screen that includes an image showing a training character whose setting has been cleared.

FIG. 17 is a flowchart illustrating an example of the process flow of training a reference character from the setting screen in the game system for a fourth embodiment.

FIG. 18 is a diagram illustrating an example of a setting screen for setting a set character.

### DETAILED DESCRIPTION OF EMBODIMENTS

Several embodiments of the present invention will now be described with reference to the accompanying drawings. In order to facilitate understanding of the description, the same constituent elements and steps are denoted by the same reference numerals as much as possible in each drawing, and duplicate descriptions are omitted.

### First Embodiment

First, the first embodiment will be described.

### Overall Configuration

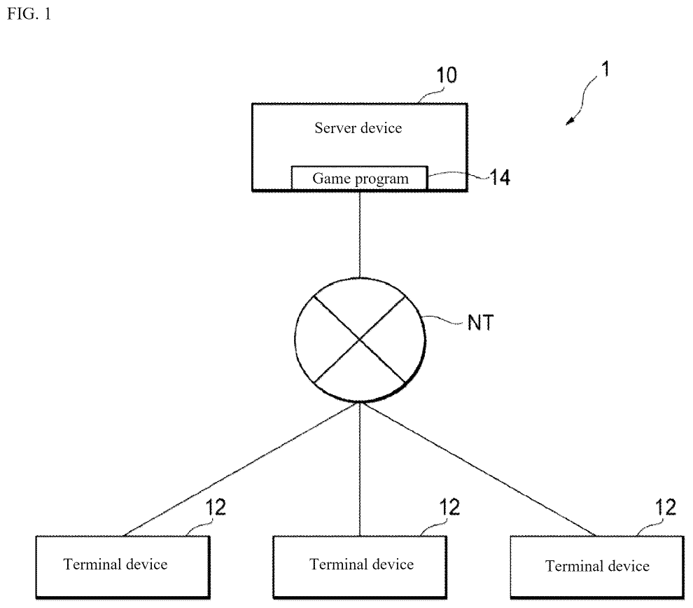

FIG. 1 is an example of a network configuration of a sales processing system 1 according to the first embodiment.

As illustrated in FIG. 1, the game system 1 includes a server device 10 and one or more terminal devices 12. The server device 10 and the terminal device 12 are connected via a communication network NT such as an intranet, the Internet, or a telephone line so as to be capable of communication.

The server device 10 is an information processing device that provides the results of the game executed by executing instructions such as a game program 14, or the instructions themselves, to a player of the terminal device 12 via a communications network NT. In the first embodiment, the server device 10 provides the instructions themselves to the player of the terminal device 12.

Each terminal device 12 is an information processing device owned by each player, and after the instructions received from the server device 10 is installed, this is executed to provide each player with a game. These terminal devices 12 include video game machines, arcade game machines, and mobile phones, and examples of such devices include smartphones, tablets, and personal computers.

### Hardware Configuration

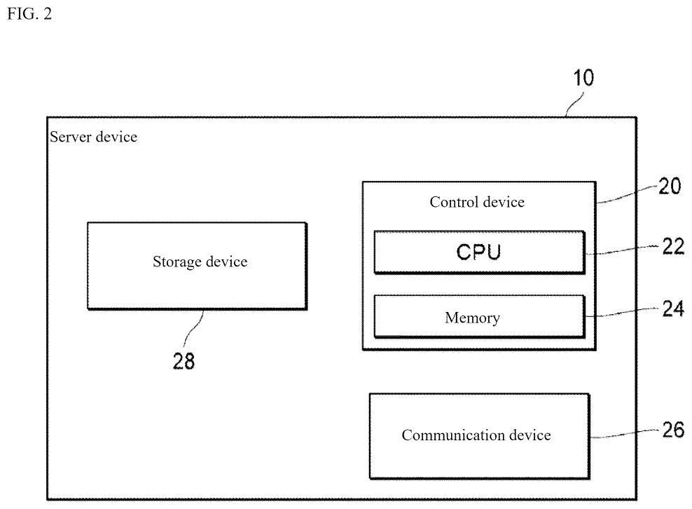

FIG. 2 illustrates a schematic diagram of an example of the hardware configuration of the server device 10.

As illustrated in FIG. 2, the server device 10 includes a control device (or hardware processor) 20 and a communication device 26, and a storage device 28. The control device 20 is mainly composed of a CPU (Central Processing Unit) 22 and a memory 24.

In the control device 20, the CPU 22 executes predetermined instructions stored in the memory 24 or the storage device 28, thereby functioning as various functional units. The details of this function will be described later.

The communication device 26 is composed of a communication interface for communicating with an external device. The communication device 26 transmits and receives various types of information to and from the terminal device 12, for example.

The storage device 28 is configured with a hard disk or the like. This storage device 28 stores various instructions and information necessary for executing processes in the control device 20, including the game program 14, as well as information on the results of the processes.

The server device 10 can be realized using an information processing device such as a dedicated or general-purpose server computer. Furthermore, the server device 10 may be configured from a single information processing device, or may be configured from a plurality of information processing devices distributed over the communications network NT. Also, FIG. 2 illustrates only a portion of the main hardware configuration of the server device 10, and the server device 10 may include other configurations that are generally included in servers. Furthermore, the hardware configuration of the multiple terminal devices 12 may also be similar to that of the server device 10, except that they include, for example, an operating device, a display device, and a sound output device.

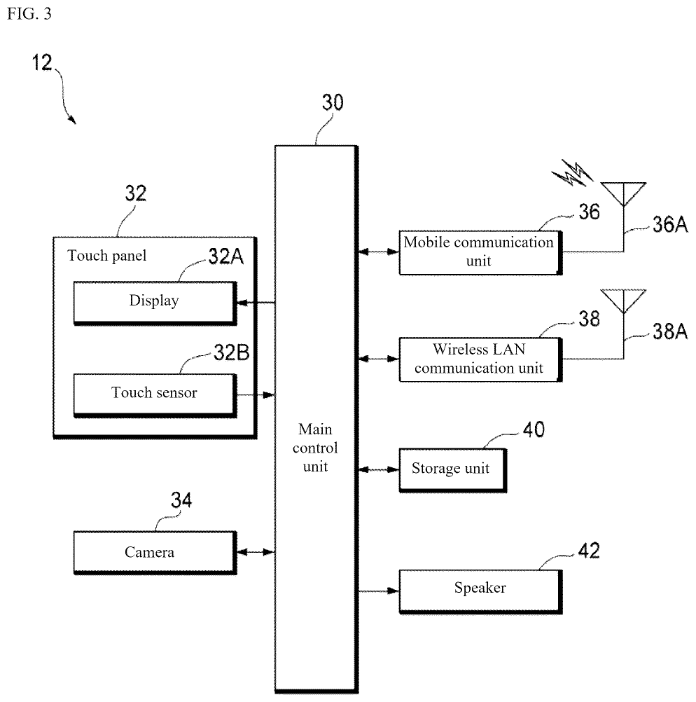

FIG. 3 illustrates an example of the hardware configuration of a smartphone as terminal device 12 illustrated in FIG. 1.

As illustrated in FIG. 3, the terminal device 12 includes a main control unit 30, a touch panel (touch screen) 32, a camera 34, a mobile communication unit 36, a wireless LAN communication unit 38, a storage unit 40, and a speaker 42.

The main control unit 30 includes a CPU, a memory, and the like. The main control unit 30 is connected to a touch panel 32 serving as a display input device, a camera 34, a mobile communication unit 36, a wireless LAN communication unit 38, a storage unit 40, and a speaker 42. The main control unit 30 has a function of controlling these connection destinations.

The touch panel 32 has both a display function and an input function, and is composed of a display 32A that performs the display function and a touch sensor 32B that performs the input function. In the first embodiment, the display 32A is capable of displaying game images including operation input images such as button images, cross key images, and joystick images. The touch sensor 32B is capable of detecting an input position of the player relative to the game image.

The camera 34 has a function of taking still images and/or moving images and storing them in the storage unit 40.

The mobile communication unit 36 is connected to a mobile communication network via an antenna 36A and has a function of communicating with other communication devices connected to the mobile communication network.

The wireless LAN communication unit 38 has a function of connecting to the communication network N T via an antenna 38A and communicating with other devices such as the server device 10 connected to the communication network NT.

The storage unit 40 stores various instructions and data such as the game program 14 and play data indicating the progress of the game of the game program 14 and player information. Furthermore, the play data may be stored in the server device 10.

The speaker 42 has a function of outputting game sounds and the like.

### Game Overview

The game according to the first embodiment includes a lottery game or quest in which a character can be acquired as an example of content, and a training game in which the content (character) is trained. This lottery game is sometimes called gacha, raffle, summon, or the like. This quest may also be called a fighting game, a dungeon, an exploration, a mission, or the like.

The lottery game according to the first embodiment is a game in which, upon an execution request (instruction) from the player to play the lottery game, the player is provided with one or more characters (content) selected by lottery (randomly selected) from a group of lottery-subject characters (lottery-subject content group) that are the subject of the lottery. This lottery game is executed based on the consumption of game currency owned by the player.

This game currency includes, for example, paid currency and free currency. Paid currency is paid content that is given to a player based on payment of money, prepaid cards, credit cards, electronic money, crypto assets, or the like. Examples of paid currency include charged items (paid items), charged coins (paid coins), charged points (paid points), or the like. For example, in the game of the first embodiment, one charged item can be purchased for 160 yen. Conversely, free currency is free content that is given to a player by playing a game. Examples of free currency include non-charged items (free items), non-charged coins (free coins), and non-charged points (free points). This game execution includes the player logging into the game, winning a quest, completing a mission, or the like. Free currency can be consumed in various games without distinction from paid currency. For example, in a certain lottery game, charged items and non-charged items can be consumed without distinction. Furthermore, in another lottery game, only charged items may be consumed.

In addition, a quest in the first embodiment is a game in which a deck (party) made up of characters owned by the player is pitted against enemy characters (including boss characters) that appear, based on instructions (requests) from the player to carry out a specified quest.

For example, a player can organize a deck to be used in a quest by, as desired, selecting a predetermined number (for example, five) or less of characters from the owned characters in an organization menu for organizing a deck to be used in a quest in advance. When a player clears a quest, the player can receive a clear reward. Examples of clearing a quest include defeating all enemy characters that appear in the quest (reducing their hit points to zero or less) or defeating the boss character that appears at the end of the quest. This clear reward may be, for example, game currency (non-charged items), enemy characters that appear in the quest, player experience points, various items, and the like.

The training game of the first embodiment is a game in which a player designates a character from among owned characters (owned content) as the training character, and the character is then strengthened or evolved by consuming the player's own costs (material content). This cost (material content) includes material characters, material items (strengthening agents), coins, currency items, and the like.

In the training game of the first embodiment, a first character synthesis is performed in which predetermined material content is consumed for each predetermined parameter (for example, level) of the training character, thereby increasing (changing) the predetermined parameter of the training character.

For example, the player can select the owned characters (strengthening) tab in the character menu, and then specify one character from the list of owned characters to make that one character a training character. By designating this training character, the player can make a request (strengthening instruction) to increase a predetermined parameter of the training character on a training screen including an image showing the training character. In the first embodiment, when this request is made, predetermined material content is consumed for each predetermined parameter (for example, level) of the training character.

In addition, in the training game according to the first embodiment, as a second character synthesis, an evolutionary synthesis is performed in which the training character evolves by consuming material content that has been previously associated with the training character. Examples of the pre-associated material content include a character with the same name as the character being trained (same type of character), a character with the same attributes as the character being trained, or the like. Examples of the evolution of a training character include an increase in the rarity of the training character and an increase in the upper limit of a predetermined parameter (for example, level) of the training character.

For example, a player can select the evolve tab in the character menu and then designate a character from among his or her characters to be the training character. The player can specify the training character and issue a request to evolve the character (an evolution instruction). In the first embodiment, when this request is made, material content that is associated with the training character in advance is consumed.

In addition, in the training game of the first embodiment, the predetermined parameters of the set character (setting content) described below automatically match (link) with the predetermined parameters of the reference character (reference content) described below, and thus the set character cannot be designated as a training target. That is, after the player selects the owned characters tab in the character menu, the player cannot specify a set character from the list of owned characters.

For example, when a player wishes to increase a predetermined parameter of a set character, the player must increase the predetermined parameter of a reference character, or cancel the setting of the set character on the setting screen and then designate the set character as a training character.

### Functional Units

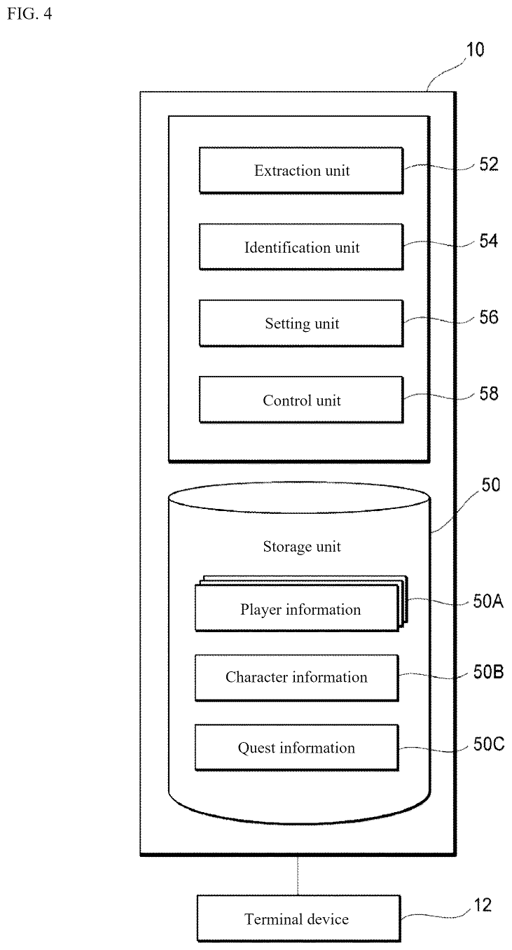

FIG. 4 is a block diagram outlining an example of the functional units of the server device 10.

As illustrated in FIG. 4, the server device 10 includes, as functional components, a storage unit 50, an extraction unit 52, a specification unit 54, a setting unit 56, and a control unit 58. The storage unit 50 is realized by one or more storage devices 28. The functional units other than the storage unit 50 are realized by the control device 20 executing the instructions stored in the storage device 28 or the like. Furthermore, some or all of these functional configurations may be provided in the terminal device 12. Furthermore, some or all of the processing performed by these functional configurations may be executed by the terminal device 12.

Furthermore, the storage unit 50, extraction unit 52, identification unit 54, setting unit 56, and control unit 58 in this embodiment may be read as a storage unit 50, an extraction unit 52, an identification unit 54, a setting unit 56, and a control unit 58, respectively.

The storage unit 50 has a function of storing player information 50A, character information 50B, quest information 50C, and the like.

The player information 50A is stored for each player in association with the player ID of the player. The player information 50A may include, for example, the player's name, age, player rank, owned content information, reference character information, set character information, number of setting possible, or the like.

The player rank increases, for example, when the player acquires player experience points.

The owned content information includes owned character information, owned item information, and the like.

The owned character information is stored for each owned character owned by the player in association with an owned character ID. This character ID is, for example, allocated each time a player acquires (owns) a character. For example, the more recently a character is acquired by a player, the higher the value of the owned character ID. Also, for example, the owned character IDs of characters of the same type each include different numerical values. The owned character information includes, for example, the character's character ID and ability parameters. Examples of ability parameters include level, hit points, attack power, defense power, and the like. In the first embodiment, for example, when a character's level increases through a training game, the character's hit points, attack power, defense power, and the like increase.

The owned item information includes item IDs and quantities of various items owned by the player. Examples of such items include game currency (for example, charged items and non-charged items), weapon items, armor items, and the like.

The reference character information includes the character ID owned by the reference character. This reference character is, for example, a character whose predetermined parameter (for example, level) is in a predetermined ranking (for example, third) from the top among the owned characters.

The set character information includes the character ID owned by each set character, and the predetermined parameters (for example, level) of each set character before setting. The set character is, for example, one or more characters that are set (selected) in advance by the player from among the characters owned by the player.

The number that can be set includes the number of characters (upper limit) that the player can set as a set character. This number that can be set increases, for example, as the player's rank increases or as the player spends game currency.

Character information 50B is stored for each character in association with the character ID of that character. The character information 50B includes, for example, the character's name and image (character image or icon image), ability information, rarity, and the like. This character information 50B is updated as the game operator updates the game.

Ability information includes initial values and upper limits of ability parameters (level, hit points, or the like), skills, or the like. Skills include abilities to recover hit points for friendly characters in a quest or to inflict large damage on enemy characters.

Rarity includes numbers ranging from 1 to 6, for example. This number may be indicated, for example, by a number of stars. In this case, characters with high rarity are set with advantageous ability parameters (for example, upper level limit) and skills in the game (for example, quests).

Quest information 50C is stored for each quest in association with the quest ID of the quest. The quest information 50C includes the name and difficulty of the quest, enemy character information, and reward information for completion.

The difficulty level includes numbers from 1 to 6, for example. The difficulty level, for example, indicates that the higher the number, the more difficult it is to complete.

The enemy character information includes the character ID and ability parameters of each enemy character that appears in the quest.

The completion reward information includes a completion reward that can be acquired when the quest is completed. Examples of this clear reward include game currency (non-charged items), character IDs of obtainable characters, player experience points, various items, and the like. For example, the more difficult the quest, the greater the reward for clearing it. For example, the reward for completing a certain quest may include 300 pieces of game currency and a weapon item.

The extraction unit 52 is a functional unit for extracting a predetermined number of characters. In the first embodiment, the extraction unit 52 extracts a predetermined number of characters from among the characters owned by the player in descending order of a predetermined parameter (for example, level). An example of this predetermined number is three. In other words, the extraction unit 52 extracts, from among the owned characters, characters whose predetermined parameters are ranked from the top to a predetermined rank (for example, third) as high-ranking characters. For example, when extracting a specified number of characters, when there are multiple characters with the same predetermined parameters, the extraction unit 52 will preferentially extract from among the multiple characters the character with the highest numerical value contained in its owned character ID (the character with the latest acquisition date and time).

Furthermore, the extraction unit 52 extracts a predetermined number of characters from among the owned characters, excluding characters that have already been set as set characters. Furthermore, when the predetermined parameters of a character that has already been set as a set character are ranked in a specified order from the top, the extraction unit 52 may cancel the setting of the set character using the setting unit 56 and extract the character.

The identification unit 54 is a functional unit for identifying one character as a reference character. In the first embodiment, the designating unit 54 specifies, from among the predetermined number of characters extracted by the extracting unit 52, the character having the lowest predetermined parameter (for example, level) as the reference character. For example, when there are multiple characters with the lowest predetermined parameters among the extracted specified number of characters, the identification unit 54 identifies the character with the highest numerical value contained in the owned character ID (the character with the latest acquisition date and time) as the reference character. Next, the specification unit 54 stores the owned character ID of the specified reference character in the reference character information of the player information 50A.

In other words, the specification unit 54 specifies, as the reference character, a character whose predetermined parameter is ranked in a predetermined order (for example, third) from the top among the characters owned by the player.

The setting unit 56 is a functional unit for setting a character as a set character. In the first embodiment, the setting unit 56 sets some or all of the owned characters not extracted by the extraction unit 52 as set characters. For example, the setting unit 56 sets, on the setting screen, one or more characters selected by the player from among the owned characters not extracted by the extraction unit 52, as set characters. That is, the setting unit 56 sets one or more characters selected by the player from the high-ranking owned characters extracted by the extraction unit 52, as set characters. Next, the setting unit 56 stores the owned character ID of the set character in the set character information of the player information 50A.

The setting unit 56 also manages the settable number of set character information in the player information 50A. For example, the setting unit 56 increases the settable number when the player's rank increases or when the player consumes game currency.

Furthermore, the setting unit 56 cancels the setting of a set character in response to an instruction from the player to cancel the setting of the set character on the setting screen (for example, pressing a setting cancel button). For example, the setting unit 56 refers to the set character information in the player information 50A and returns (for example, lowers) a predetermined parameter of the set character to the predetermined parameter before the setting. Next, the setting unit 56 deletes the information of the character whose setting has been cancelled from the set character information of the player information 50A.

The control unit 58 is a functional unit for controlling the entire game. In the first embodiment, the control unit 58 causes the predetermined parameters of each set character to match the predetermined parameters of a reference character (reference parameters). For example, the control unit 58 refers to the owned character information, set character information, and reference character information in the player information 50A, and matches (links) a predetermined parameter (for example, level) of one or more set characters with a predetermined parameter (for example, level) of the reference character. Here, when the control unit 58 matches the predetermined parameters of the set character with the predetermined parameters of the reference character, it does not consume the cost (material contents) associated with the player (owned by the player). In other words, the control unit 58 automatically matches the predetermined parameters of each set character with the predetermined parameters of the reference character.

Furthermore, the control unit 58 displays change information indicating that the reference character has been changed to another character. For example, the control unit 58 displays change information on the touch panel 32 of the terminal device 12 held by the player based on a change in the owned character ID included in the reference character information of the player information 50A at a specified timing (for example, a timing when a predetermined parameter of the owned character changes).

For example, the modification information includes a name or an image of another character (a reference character) that has been modified. Specifically, the control unit 58 refers to the reference character information of the player information 50A, the character information 50B, or the like, and causes the touch panel 32 to display change information including the name or image of the changed different character.

Also, for example, the modification information includes a predetermined parameter of another character (reference character) that has been modified. Specifically, the control unit 58 refers to the possessed character information and the reference character information of the player information 50A, and determines a predetermined parameter (for example, a level) of the changed different character (reference character) is displayed on the touch panel 32.

Furthermore, the control unit 58 increases a predetermined parameter of a training character in response to a request (strengthening instruction) from the player to train the training character on a training screen that includes an image of the training character designated by the player as the training target from among the owned characters. Examples of the image representing the training character include the name and image of the training character. For example, when increasing a predetermined parameter of a training character, the control unit 58 consumes a cost associated with the player (for example, material content owned by the player).

Furthermore, in the first embodiment, the control unit 58 prohibits the player from training a setting character from among the owned characters. For example, the control unit 58 prohibits designating a set character from the list of owned characters as a training character, and the training screen is not opened. When a set character is designated as a training character from the list of owned characters, the control unit 58 may disable a strengthening instruction for the set character on the training screen (disable the strengthening button).

By configuring in this way, it is possible to suppress the complexity of the process of matching the predetermined parameters and the confusion that may occur to the player.

Furthermore, when the reference character is changed to another character as a result of increasing a predetermined parameter of the training character, the control unit 58 displays change information on the training screen.

For example, the change information includes a query as to whether to switch the training character to another changed character (reference character). For example, when a switching request (switching instruction) is received from the player, the control unit 58 switches the training character to another changed character (reference character).

Furthermore, the change information may be information for automatically switching the training character to another character (reference character) without a query. For example, the training screen may display an image indicating that the training character has been switched to another character (reference character) or the changed character (reference character).

Furthermore, when a request is made by the player to switch the training character to another character (reference character), the control unit 58 may automatically switch the training character to another character (reference character) without making any query from the second time onwards. Similarly, when a request not to switch is made by the player, the control unit 58 may not make a query from the second time onwards, and may not switch the training character.

According to this configuration, even when the reference character is frequently changed, the player will not feel bothered.

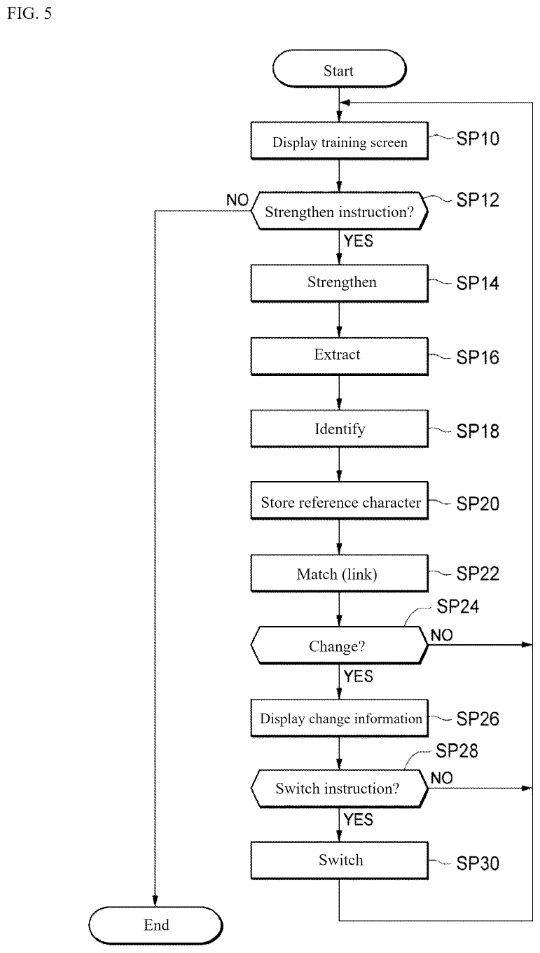

### Display Process Flow

[FIG. 5] A flowchart illustrating an example of the process flow of displaying change information indicating that the reference character has been changed in the game system 1 according to the first embodiment. Furthermore, the process of the following steps is initiated when the player selects the owned characters tab in the character menu and then designates one character (character C) from the list of owned characters as a training character. The order and content of the following steps may be changed as appropriate.

### Step SP10

The control unit 58 causes the touch panel 32 to display a training screen including an image showing a training character. For example, this training character is a reference character.

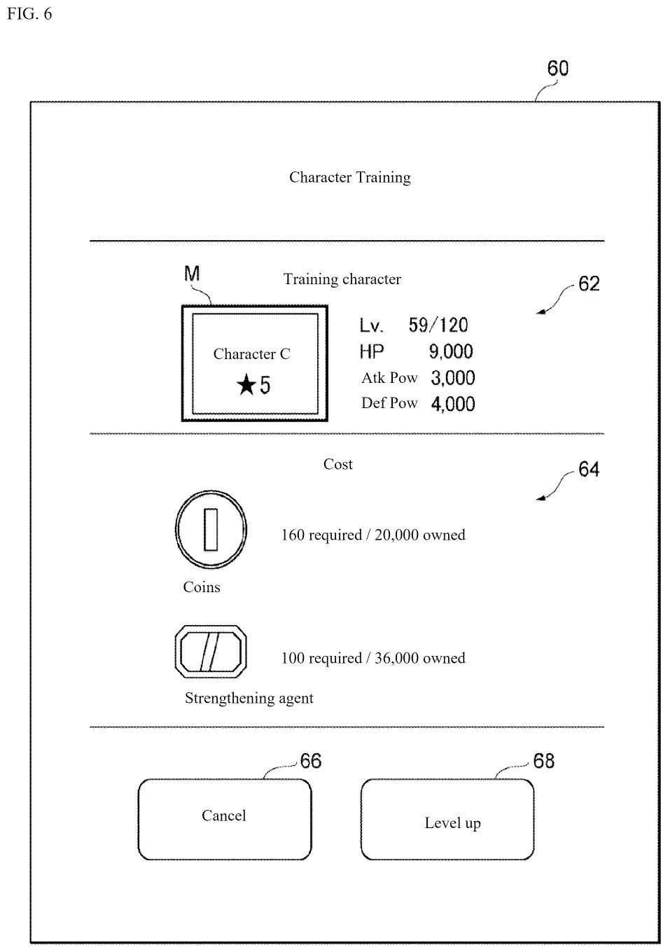

FIG. 6 illustrates an example of a training screen 60 that includes an image showing a training character.

As illustrated in FIG. 6, the character training screen 60 is provided with a character training information area 62, a cost information area 64, a cancel button 66, and an strengthening button 68.

The training character information area 62 displays an image of the training character, ability parameters including predetermined parameters (level), and the like. Further, the image showing the training character has a mark M indicating that the training character (character C) is a reference character.

The cost information area 64 indicates the cost (material content) required to increase the predetermined parameter (level) of the character being trained by one level, and the cost owned by the player.

The cancel button 66 is a button for issuing an instruction to return to the screen listing the owned characters without training the training character (strengthening the predetermined parameters).

The strengthening button 68 is a button for issuing an instruction to increase a predetermined parameter (level) of the character being trained. For example, each time the player presses the strengthening button 68, the player can increase a predetermined parameter of the character being trained by one. It should be noted that this strengthening button 68 can be instructed when the predetermined parameter of the character being trained is lower than the upper limit value and when the player has the cost. Furthermore, when a predetermined parameter of the training character reaches the upper limit, this strengthening button 68 is replaced with a button for issuing an instruction to move to a screen for evolving the training character.

Returning to FIG. 5, the process proceeds to step SP12.

### Step SP12

The control unit 58 determines whether a strengthening instruction has been issued by the player. For example, the control unit 58 determines whether the strengthening button is pressed on the training screen. If the determination is affirmative, the process proceeds to step SP14. Conversely, if the determination is negative, that is, when the cancel button is pressed, the series of processes illustrated in FIG. 5 is ended.

### Step SP14

The control unit 58 consumes the cost (material content) owned by the player to perform strengthening synthesis to increase a predetermined parameter (for example, level) of the character being trained by 1. Then, the process proceeds to step SP16.

### Step SP16

The extraction unit 52 refers to the owned character information in the player information 50A, and extracts a predetermined number (for example, three) of characters from among the owned characters in descending order of a predetermined parameter (for example, level). For example, the extraction unit 52 extracts character A whose predetermined parameter is 90, character B whose predetermined parameter is 65, and character C whose predetermined parameter is 60 from the owned characters. The process then moves to step SP18.

### Step SP18

The identification unit 54 defines, as a reference character, the character having the lowest predetermined parameter (for example, level) from among the predetermined number of characters extracted in step SP16. For example, the identification unit 54 identifies character C, whose predetermined parameter is 60, as the reference character. The process then moves to step SP20.

### Step SP20

The identifying unit 54 stores the character ID owned by the reference character (character C) identified in step SP18 in the reference character information in the player information 50A. The process then moves to step SP22.

### Step SP22

The control unit 58 refers to the owned character information of the player information 50A, the set character information, and the reference character information to match (link) the predetermined parameters (for example, level) of each of the set characters to the predetermined parameters of the reference character. For example, the control unit 58 stores the predetermined parameters of each set character in the possessed character information of the player information 50A as the predetermined parameters (reference parameters) 60 of a reference character (character C). The process then moves to step SP24.

### Step SP24

The control unit 58 determines whether the reference character has been changed to another character. For example, the control unit 58 determines whether the owned character ID included in the reference character information of the player information 50A in step SP20 has been changed to another owned character ID. If the determination is positive, the process moves to step SP26. Conversely, if the determination is negative, the process moves to step SP10.

### Step SP26

The control unit 58 causes the touch panel 32 to display a training screen including the change information.

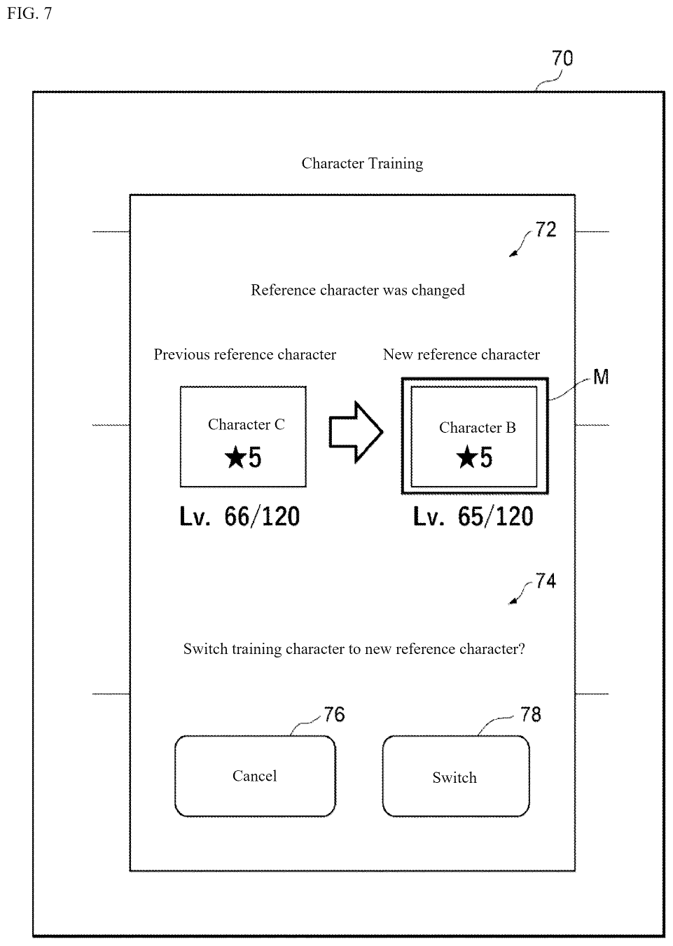

FIG. 7 illustrates an example of a training screen 70 with change information.

As illustrated in FIG. 7, the training screen 70 is provided with a change information area 72, a query information area 74, a cancel button 76, and a switch button 78.

The change information area 72 displays information indicating that the reference character has been changed to another character, an image and predetermined parameters of the previous reference character (character C), an image and predetermined parameters of a new reference character (character B), or the like. Furthermore, the image showing the new reference character is marked with the mark M indicating that such is the reference character.

The query information area 74 displays a query as to whether to switch the training character to a new reference character (character B).

The cancel button 76 is a button for issuing an instruction to continue training the character without switching the training character.

The switch button 78 is a button for issuing an instruction to switch the training character to a new reference character (character B).

Returning to FIG. 5, the process moves to step SP28.

### Step SP28

The control unit 58 determines whether a switching instruction is given by the player. For example, the control unit 58 determines whether the switch button is pressed on the training screen containing the change information. If the determination is negative, that is, when the cancel button is pressed and the training character is to be continued without switching, the process proceeds to step SP10.

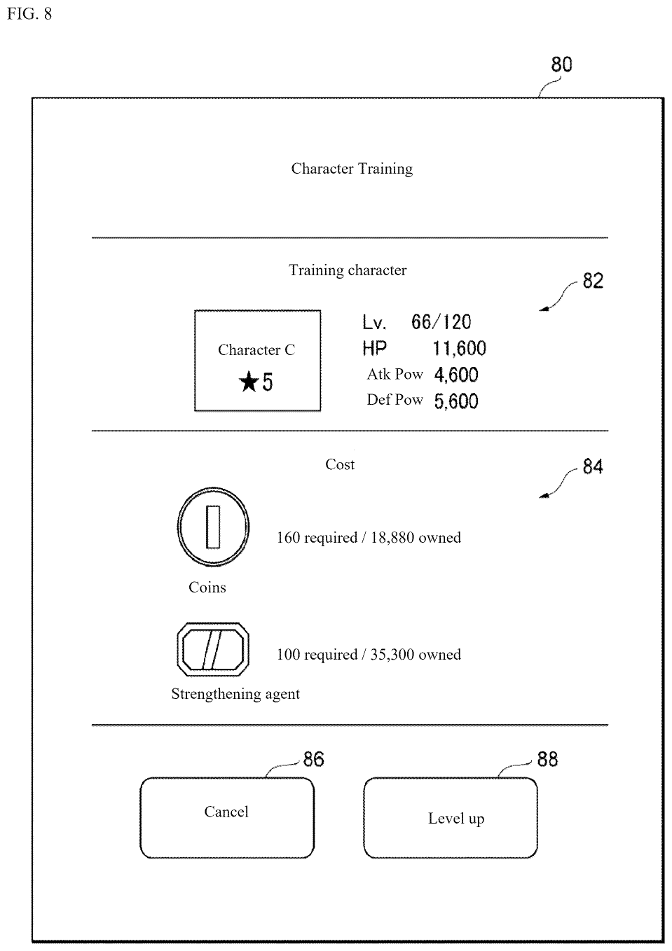

FIG. 8 illustrates an example of a training screen 80 when training is continued without switching training characters.

As illustrated in FIG. 8, the training screen 80 has a training character information area 82, a cost information area 84, a cancel button 86, and a strengthening button 88.

In the character information area 82, an image showing the character being trained and ability parameters, including predetermined parameters (level), are represented.

Returning to FIG. 5, when the determination in step SP28 is affirmative, the process proceeds to step SP30.

### Step SP30

The control unit 58 switches the training character to the reference character. The process then moves to step SP10.

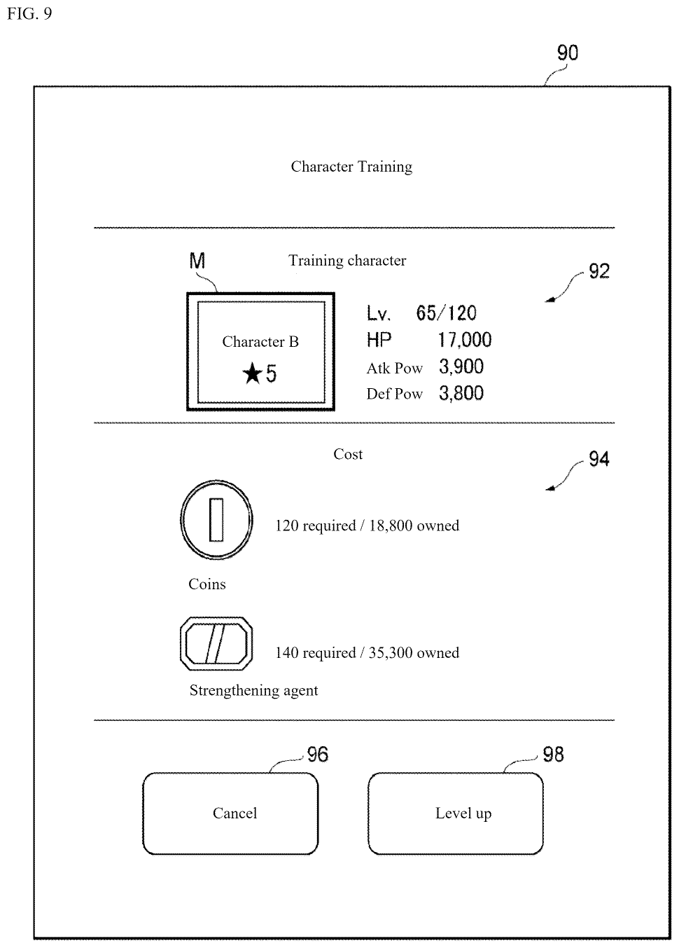

FIG. 9 illustrates an example of a training screen 90 with the training character switched to the reference character.

As illustrated in FIG. 9, the training screen 90 has a training character information area 92, a cost information area 94, a cancel button 96, and a strengthening button 98.

In the character information area 92, an image showing the character being trained and ability parameters, including predetermined parameters (level), are represented. The image showing the training character is marked with the mark M indicating that the training character (character B) is the reference character.

### Technical Effect

As described above, in the first embodiment, a computer is caused to function as the extraction unit 52 for extracting a predetermined number of owned contents in descending order of predetermined parameters, the specification unit 54 for designating, from the extracted content, the content with the lowest predetermined parameter as reference content, the setting unit 56 for setting some or all of the owned content not extracted as set content, and the control unit 58 for matching the predetermined parameters of each of the set content with the predetermined parameters of the reference content, and the control unit 58 displays change information indicating that the reference content has been changed to other content.

According to this configuration, change information is displayed based on the fact that the reference content has been changed to other content, and thus the player can easily recognize the reference content that serves as the reference for the predetermined parameter.

In the first embodiment, the change information includes the name or image of other content that has been changed.

According to this configuration, since the name or image of the changed different content is included in the change information, it is possible to allow the player to easily recognize the reference content that serves as the reference for the predetermined parameter.

Also, in the first embodiment, the change information includes the predetermined parameters of other content that has been changed.

According to this configuration, since the predetermined parameters of other content that has been changed are included in the change information, players can easily recognize the predetermined parameters of the reference content that is the basis for the predetermined parameters.

Furthermore, in the first embodiment, the control unit 58 sets, as training content, content designated by the player as a training target from among the owned content, and in response to a request from the player to train the training content, increases a predetermined parameter of the training content on a training screen including an image showing the training content, and when the reference content is changed to other content as a result of increasing the predetermined parameter of the training content, the control unit 58 displays the change information on the training screen.

According to this configuration, the change information is displayed on the training screen, and thus the player who is training the content can easily recognize the reference content that serves as the reference for the predetermined parameter.

In the first embodiment, the change information includes a query as to whether to switch the training content to a different content that has been changed, and the control unit 58 switches the training content to a different content that has been changed when the player requests the switch.

According to this configuration, the player can request that the training content be switched to another changed content, and thus the player can easily recognize the reference content that serves as the basis for the predetermined parameters. Furthermore, the player can easily increase the predetermined parameter of the changed different content (reference content), and thereby easily match (increase) the predetermined parameter of the set content.

Furthermore, in the first embodiment, the change information is to switch the training content to other content that has been changed.

According to this configuration, since the training content is changed to other content which is changed to the reference content, the player does not feel bothered. Furthermore, the player can easily increase a predetermined parameter of the other content (reference content).

Also, in the first embodiment, the control unit 58 consumes the cost associated with the player when increasing the predetermined parameter of the training content.

According to this configuration, it is possible to prevent the player from erroneously increasing the predetermined parameters of owned content other than the reference content, thereby consuming costs.

Also, in the first embodiment, the control unit 58 does not consume any cost in matching the predetermined parameters of the configuration content with the predetermined parameters of the reference content.

According to this configuration, the player can reduce the effort required to obtain the cost for training set content, thereby providing the player with motivation to play the game.

### Second Embodiment

Next, the second embodiment will be described.

The second embodiment differs from the first embodiment in that, based on the designation of a set character as a training character, the control unit 58 switches the training character to a reference character. The configuration and functions of the game system according to the second embodiment, which are not described below, are similar to those of the game system according to the first embodiment.

In the second embodiment, the control unit 58 switches the training character to the reference character based on the designation of the set character as the training character. For example, when a set character is designated as a training character, the control unit 58 switches the training character to the reference character. Next, the control unit 58 displays a training screen including an image showing the reference character. For example, this training screen includes information indicating that the designated training character was a set character and therefore the training character has been switched to a reference character.

For example, when a set character is designated as a training character, the control unit 58 inquires whether the training character should be switched to the reference character. Next, in response to the query, when there is a request to switch (switch instruction) from the player, the control unit 58 switches the training character to the reference character. Next, the control unit 58 displays a training screen including an image showing the reference character.

Conversely, if the player requests not to switch in response to the query, the control unit 58 does not switch the training character to the reference character, erases the query, and displays an owned character list screen for designating the training character.

It should be noted that the setting unit 56 may cancel the setting of the training character (set character) when there is a request from the player not to switch. Next, the control unit 58 displays a training screen including an image showing the character whose setting as a training character has been cancelled.

Furthermore, when a set character is designated as a training character, the control unit 58 accepts an instruction from the player to switch the training character to a reference character on a training screen including an image showing the training content. That is, even when a set character is designated as a training character, the control unit 58 does not inquire as to whether to switch the training character to the reference character, but instead displays the training screen. In this training screen, for example, there is no strengthening button for issuing instructions to strengthen the training character (set character) (it is disabled), but instead there is a switching button for issuing instructions to switch the training character to a reference character. Next, the control unit 58 switches the training character to the reference character on the training screen in response to the instruction to switch from the player (pressing the switching button).

Furthermore, this training screen may be provided with a clear setting button for issuing an instruction to cancel the setting of the training character (set character). For example, the setting unit 56 cancels the setting of the training character in response to an instruction to cancel (pressing the clear setting button). Next, the control unit 58 provides (enables) a strengthening button on the training screen.

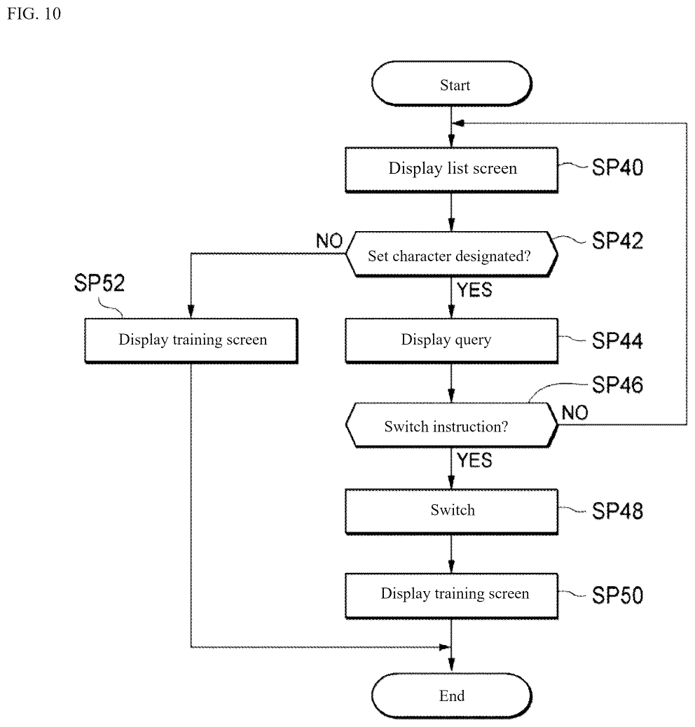

### Switching Process Flow

[FIG. 10] A flowchart illustrating an example of the process flow of switching a training character to a reference character in the game system 1 for the second embodiment. Furthermore, the process of the following steps is initiated, for example, when the player selects the tab for the owned character in the character menu. The order and content of the following steps may be changed as appropriate.

### Step SP40

The control unit 58 causes the touch panel 32 to display an owned character list screen on which the player can specify a training character.

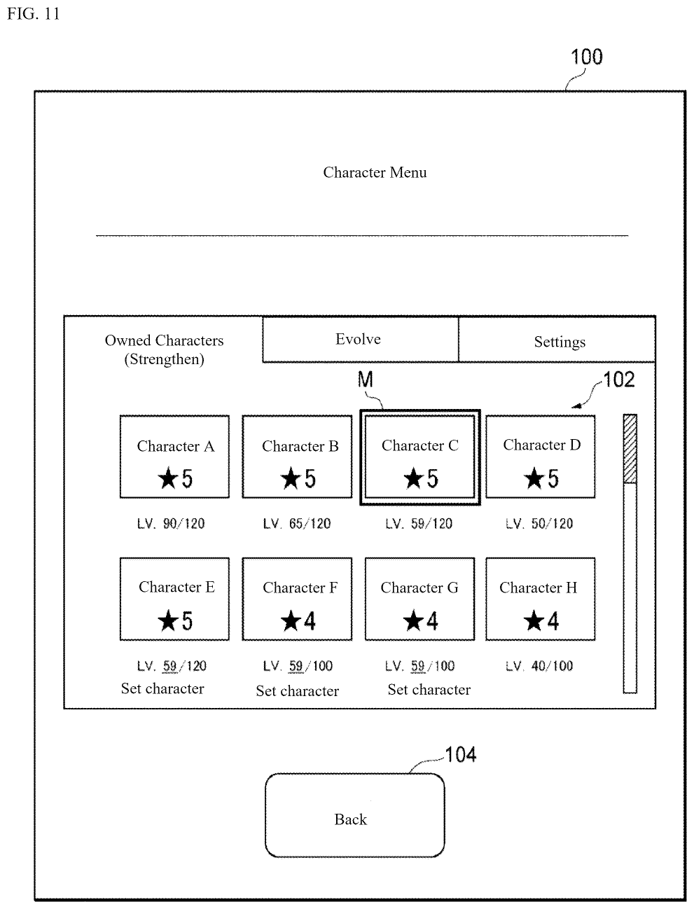

FIG. 11 illustrates an example of an owned character list screen 100, which specifies the characters to be trained.

As illustrated in FIG. 11, the owned character list screen 100 is provided with an owned character information area 102 and a back button 104.

The owned character information area 102 displays an image of each of the player's owned characters, predetermined parameters (level), information indicating whether the character is a set character, and the like. Furthermore, in the owned character information area 102, a mark M is attached to the reference character. In the owned character information area 102, the predetermined parameters of the set character are displayed with the same values as the predetermined parameters of the reference character, and are displayed in a manner different from the predetermined parameters of characters other than the set character. The predetermined parameters before setting each set character may be represented in the owned character information area 102.

The back button 104 is a button for issuing an instruction to return (transition) from the character menu to the main menu screen. When the back button 104 is pressed, the series of processes illustrated in FIG. 10 ends.

Returning to FIG. 10, the process moves to step SP42.

### (Step SP42)

The control unit 58 determines whether the set character has been designated by the player as a training character. For example, the control unit 58 determines whether an image showing a set character has been designated (pressed) on the owned character list screen. If the determination is positive, the process moves to step SP44. Conversely, if the determination is negative, that is, when an image other than that of the set character is designated, the process proceeds to step SP52.

### Step SP44

The control unit 58 displays on the touch panel 32 an owned character list screen, including a query as to whether to switch the training character.

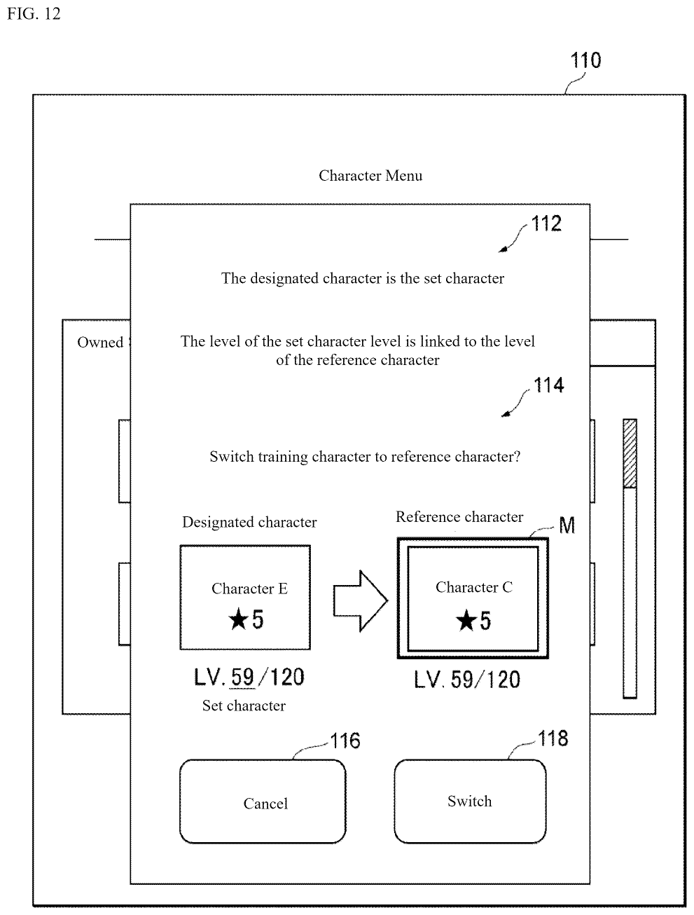

FIG. 12 illustrates an example of an owned character list screen 110 that includes a query as to whether to switch the training character.

As illustrated in FIG. 12, owned character list screen 110 is provided with a designated character information area 112, a query information area 114, a cancel button 116, and a switch button 118.

The designated character information area 112 displays information indicating that a set character has been designated as a training character.

The query information area 114 represents a query as to whether to switch the training character to the reference character (character C).

The cancel button 116 is a button for issuing an instruction to erase the query without switching the training character and to return to the screen for designating the training character (owned character list screen).

The switch button 118 is used to give instructions to switch the training character to the reference character (character C).

Returning to FIG. 10, the process moves to step SP46.

### Step SP46

The control unit 58 determines whether a switching instruction is given by the player. For example, the control unit 58 determines whether a switch button has been pressed on an owned character list screen that includes a query as to whether to switch the character being trained. If the determination is positive, the process moves to step S P48. Conversely, if the determination is negative, that is, the Cancel button is pressed, the process moves to the process of step SP40.

### Step SP48

The control unit 58 switches the training character to the reference character. The process then moves to step SP50.

### Step SP50

The control unit 58 causes the touch panel 32 to display a training screen in which the training character has been switched to the reference character.

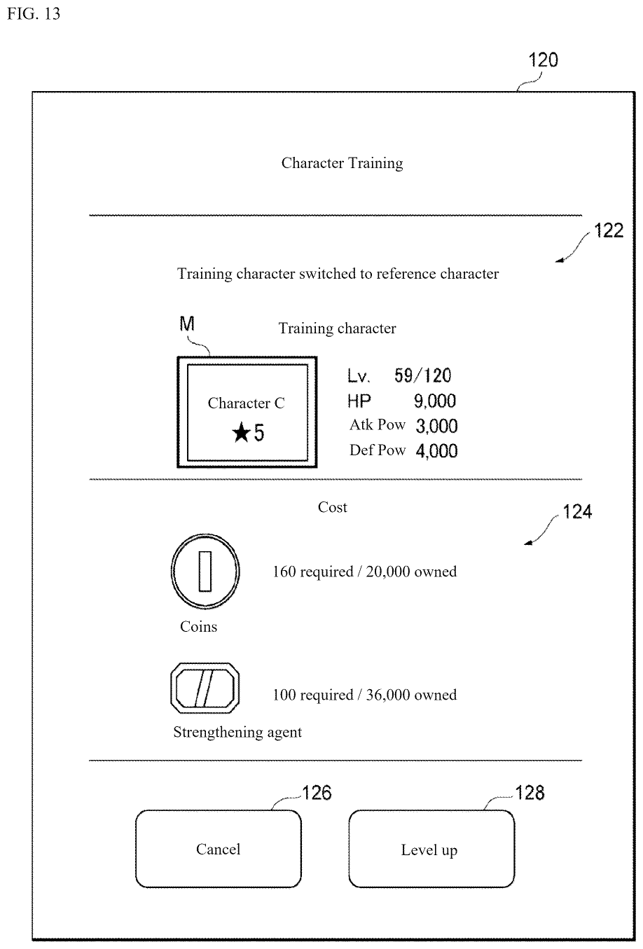

FIG. 13 illustrates an example of a training screen 120 with the training character switched to the reference character.

As illustrated in FIG. 13, the training screen 120 has a training character information area 122, a cost information area 124, a cancel button 126, and an strengthening button 128.

The training character information area 122 displays information such as that the training character has been switched to a reference character, an image showing the training character (reference character), and ability parameters including predetermined parameters (level).

Then, the series of processes illustrated in FIG. 10 is ended.

### Step SP52

The control unit 58 displays a training screen on the touch panel 32 that includes an image showing the training character that has been set. This training screen is the same as that in FIG. 8. Then, the series of processes illustrated in FIG. 10 is ended.

### Technical Effect

As described above, in the second embodiment, a computer is caused to function as the extraction unit 52 for extracting a predetermined number of owned contents in descending order of predetermined parameters, the specification unit 54 for designating, from the extracted content, the content with the lowest predetermined parameter as reference content, the setting unit 56 for setting some or all of the owned content not extracted as set content, and the control unit 58 for matching the predetermined parameters of each of the set content with the predetermined parameters of the reference content, and the control unit 58 switches the training content to the reference content based on the fact that the set content has been designated as the training content.

According to this configuration, when a set content is designated as the training content, the training content is switched to the reference content, and thus the player can easily recognize the reference content that serves as the basis for the predetermined parameters.

Furthermore, in the second embodiment, when a set content is designated as the training content, the control unit 58 makes a query as to whether to switch the training content to the reference content, and when the player requests to switch in response to the query, the control unit 58 switches the training content to the reference content.

According to this configuration, the player can make a request to switch the training content to the reference content, thus making it easier for the player to recognize the reference content as the basis for the predetermined parameter. The player can also easily increase the predetermined parameters of the reference content and thus easily match (increase) the predetermined parameters of the set content.

Furthermore, in the second embodiment, when the player requests not to switch in response to a query, the setting unit 56 cancels the setting of the training content, and the control unit 58 displays a training screen including an image showing the training content whose setting has been cleared.

According to this configuration, when the training content is not switched to the reference content, the setting of the training content is cancelled, and thus the player can train the training content immediately.

In the second embodiment, when set content is designated as the training content, the control unit 58 receives an instruction from the player concerned to switch the training content to the reference content on the training screen that includes an image showing the training content, and control unit 58 switches the content to the standard content in response to the switching instruction.

According to this configuration, even when the player designates set content as training content, an instruction to switch the training content to the reference content can be given on the training screen. Therefore, the player can easily increase the predetermined parameters of the reference content and thus easily match (increase) the predetermined parameters of the set content.

Also, in the second embodiment, the control unit 58 consumes the cost associated with the player when increasing the predetermined parameters of the training content.

According to this configuration, it is possible to inhibit players from accidentally increasing the predetermined parameters of owned content other than the reference content and consuming the cost.

Also, in the second embodiment, the control unit 58 does not consume a cost when matching the predetermined parameters of the set content with the predetermined parameters of the reference content.

According to this configuration, the player can reduce the time and effort to obtain the cost to train the set content, thereby motivating the player to play the game.

### Third Embodiment

Next, the third embodiment will be described.

The third embodiment differs from the second embodiment in that the setting unit 56 cancels the setting of the set character based on the fact that the set character has been designated as the training character. The configuration and functions of the game system for the third embodiment, not described below, are the same as those of the game system for the first and second embodiments.

In the third embodiment, the setting unit 56 cancels the setting of a set character based on the player designating the set character as a training character. For example, when a set character is designated as a training character, the control unit 58 automatically clears the setting of the set character. The control unit 58 then displays a training screen that includes an image showing the training character whose setting have been cancelled. For example, this training screen includes information indicating that the setting of the training character has been cancelled because the designated training character was a set character.

Furthermore, when a set character is designated as a training character, the control unit 58 inquires of the player as to whether to cancel the setting of the training character. Next, the setting unit 56 cancels the setting of the training character when there is a request for cancellation from the player in response to the query. Next, the control unit 58 displays a training screen including an image showing the training character whose setting has been cancelled.

Conversely, if the control unit 58 receives a request from a player not to release the character in response to a query, it erases the query and displays the owned character list screen to designate the training character.

Note that the control unit 58 may switch the training character to the reference character when the player requests not to clear the character. The control unit 58 then displays a training screen that includes an image showing a reference character as a training character.

Furthermore, when a set character is designated as a training character, the control unit 58 accepts an instruction from the player to cancel the setting of the character on the training screen that includes an image showing the character. In other words, the control unit 58 does not inquire whether to cancel the setting of the training character, even when a set character is designated as the training character, but displays the training screen. In this training screen, for example, there is no strengthening button for giving instructions to strengthen the training character (set character) (it is disabled), but instead there is a clear setting button for giving instructions to cancel the setting of the training character. Next, the setting unit 56 cancels the setting of the training character in response to an instruction to cancel (pressing the clear setting button). Next, the control unit 58 provides (enables) a strengthening button on the training screen.

Furthermore, this training screen may be provided with a switch button for issuing an instruction to switch the training character (set character) to the reference character. For example, in response to a switching instruction (pressing a switching button), the control unit 58 displays an image showing a reference character and a training screen on which an strengthening button is provided (enabled).

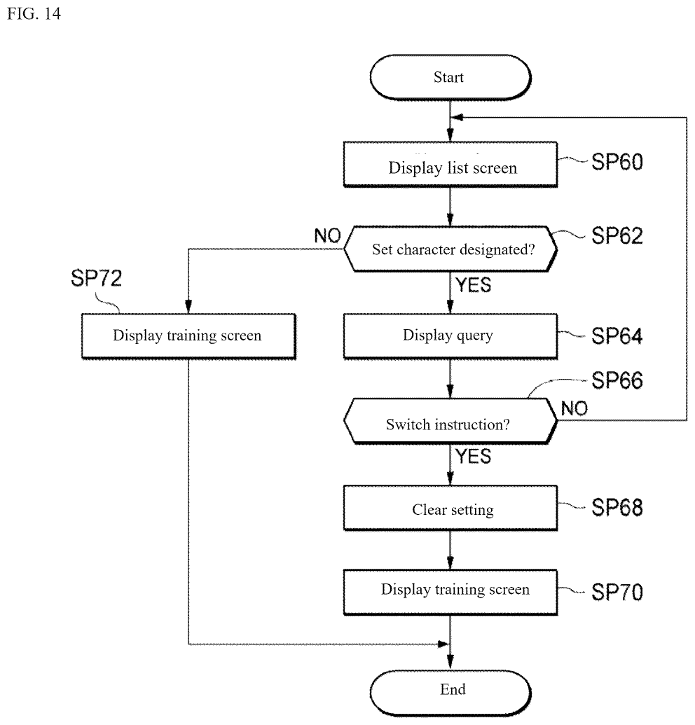

### Setting Clearing Process Flow

[FIG. 14] A flowchart illustrating an example of the process flow for clearing the setting of a training character in the game system 1 for the third embodiment. Furthermore, the process of the following steps is initiated, for example, when the player selects the tab for the owned character in the character menu. The order and content of the following steps may be changed as appropriate.

### Step SP60 to Step SP62

The processing in step SP60 to step SP62 is similar to the processing in steps SP40 to step SP42 described above, and therefore a description thereof will be omitted.

### Step SP64

The control unit 58 displays on the touch panel 32 an owned character list screen, including a query as to whether to clear the setting.

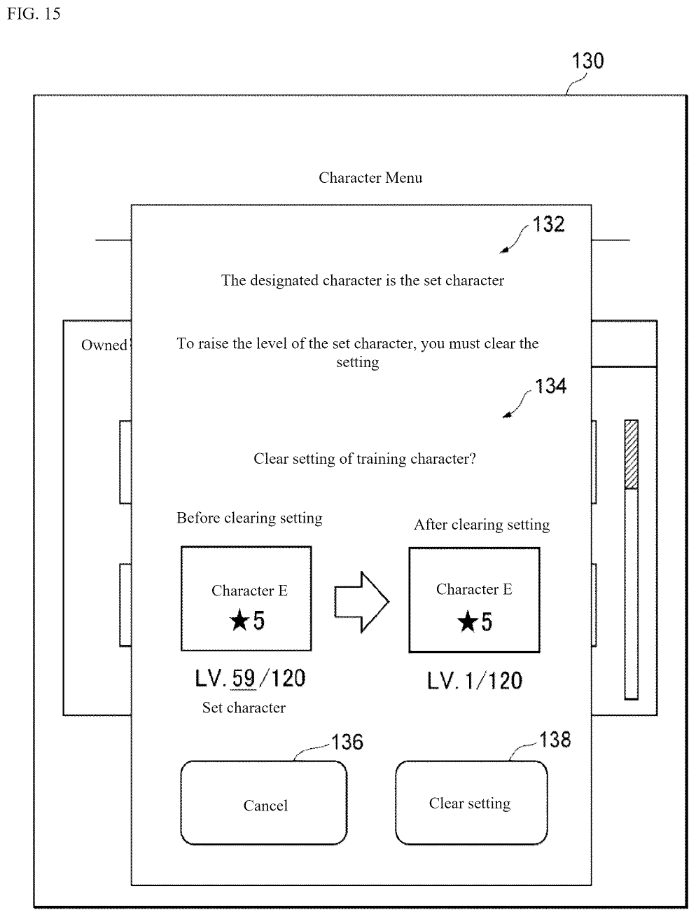

FIG. 15 illustrates an example of an owned character list screen 130 that includes a query as to whether to clear the setting.

As illustrated in FIG. 15, the owned character list screen 130 has a designated character information area 132, a query information area 134, a cancel button 136, and a setting release button 138.

In the designated character information area 132, information indicating that a set character has been designated as the training character, or the like is shown.

The query information area 134 displays a query as to whether to cancel the setting of the training character. Furthermore, the query information area 134 displays the predetermined parameters of the training character before the setting is cleared (current) and the predetermined parameters after the setting is released (before the setting).

The cancel button 136 is a button for issuing an instruction to erase the query without clearing the setting the training character and to return to the screen for designating the training character (owned character list screen).

The setting release button 138 is a button for issuing an instruction to release the setting of the training character.

Returning to FIG. 14, the process moves to step SP66.

### Step SP66

The control unit 58 determines whether a release instruction is given by the player. For example, the control unit 58 determines whether the button for clearing the setting is pressed on the owned character list screen, which includes a query as to whether the setting should be cleared. If the determination is positive, the process moves to step SP68. Conversely, if the determination is negative, that is, the Cancel button is pressed, the process moves to the process of step SP60.

### Step SP68

The setting unit 56 cancels the setting of the training character designated by the player (set character). For example, the setting unit 56 reverts the predetermined parameters of the designated training character (set character) to the predetermined parameters before setting by referring to the set character information in player information 50A. Next, the setting unit 56 deletes the information of the character whose setting has been cancelled from the set character information of the player information 50A. The process then moves to step SP70.

### Step SP70

The control unit 58 displays a training screen on the touch panel 32 that includes an image showing the training character whose setting have been cancelled.

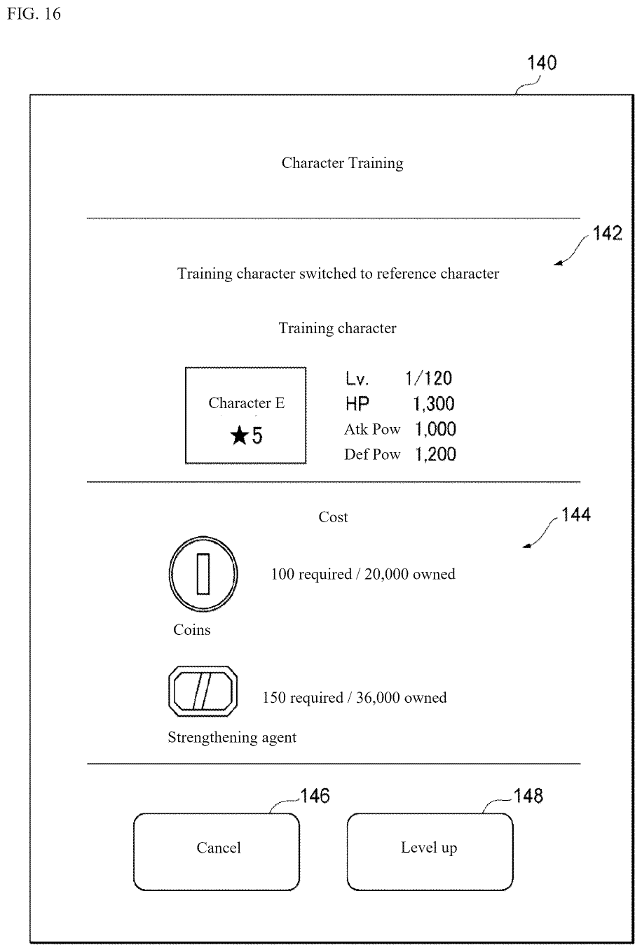

FIG. 16 illustrates an example of a training screen 140 that includes an image showing a training character whose setting have been removed.

As illustrated in FIG. 16, the training screen 140 has a training character information area 142, a cost information area 144, a cancel button 146, and a strengthening button 14 8.

The training character information area 142 displays information indicating that the training character setting has been cancelled, an image showing the training character, and ability parameters including the predetermined parameters (level) after the setting have been cleared.

Then, the series of processes illustrated in FIG. 16 is ended.

### Step SP72

The process of step SP72 is similar to the process of step SP52 described above, so description is omitted. Then, the series of processes illustrated in FIG. 16 is ended.

### Technical Effect

As described above, in the third embodiment, a computer is caused to function as the extraction unit 52 for extracting a predetermined number of owned contents in descending order of predetermined parameters, the specification unit 54 for designating, from the extracted content, the content with the lowest predetermined parameter as reference content, the setting unit 56 for setting, due to a request by the player, some or all of the owned content not extracted as set content, and the control unit 58 for matching the predetermined parameters of each of the set content with the predetermined parameters of the reference content, and the setting unit 56 clears the setting of the set content based on the fact that the set content has been designated as the training content.

According to this configuration, the setting of the set content is cancelled based on the fact that the set content has been designated as the training content, and thus the effort required of the player to directly train the set content can be reduced.

Furthermore, in the third embodiment, when the set content is designated as training content, the control unit 58 inquires of the player as to whether or not to cancel the setting of the training content, and the setting unit 56 clears the setting of the training content when the player requests cancellation in response to the query.

According to this configuration, when a configuration content is designated as a training content, the player can make a request to cancel the setting of the training content (configuration content), thus reducing the time and effort for the player to directly train the configuration content.

Furthermore, in the third embodiment, when the player makes a request not to cancel in response to a query, the control unit 58 switches the training content to the reference content.

According to this configuration, when the setting of the training content (set content) is not cancelled, the training content is switched to the reference content, thereby reducing the effort required of the player to train the reference content.

Also, in the third embodiment, when set content are designated as the training content, the control unit 58 receives an instruction from the player to cancel the setting of the content on the training screen including an image showing the content, and in response to the instruction to cancel the setting unit 56 cancels the setting of the content to be trained.

According to this configuration, even when a player specifies set content as training content, the player can give instructions on the training screen to cancel the setting of the training content, thereby reducing the effort required for the player to directly train the set content.

Also, in the third embodiment, the control unit 58 consumes the cost associated with the player when increasing the predetermined parameters of the training content.

According to this configuration, in the case where a player wishes to directly train set content by consuming costs, the effort required for such training can be reduced, thereby preventing the player's motivation for the game from decreasing.

Also, in the third embodiment, the control unit 58 does not consume any cost in matching the predetermined parameters of the configuration content with the predetermined parameters of the reference content.

According to this configuration, the player can reduce the time and effort to obtain the cost to train the set content, thereby motivating the player to play the game.

### Fourth Embodiment

Next, the fourth embodiment will be described.

The fourth embodiment differs from the first embodiment and the like in that the control unit 58 provides a designation area for training a reference character on the setting screen. The configuration and functions of the game system for the fourth embodiment, which is not described below, are the same as those of the game system for the first through third embodiments.

In the fourth embodiment, the control unit 58 provides a designation area for increasing a predetermined parameter of a reference character on a setting screen where the player sets a set character. For example, the control unit 58 provides an instruction area (training button) on the setting screen for designating a reference character as a training character and moving to a training screen where a predetermined parameter can be increased.

The control unit 58 may be provided with an strengthening button on the setting screen for issuing an enhancement instruction to increase a predetermined parameter of the reference character. For example, the control unit 58 increases a predetermined parameter of the reference character by one each time the player presses the strengthening button on the setting screen. Furthermore, this setting screen may display the cost (material content) required to increase a predetermined parameter of the reference character by one point, and the cost owned by the player.

Furthermore, when the reference character is changed to another character due to an increase in a predetermined parameter of the reference character, the control unit 58 displays change information indicating the change. The control unit 58 may display this change information on the setting screen or on the training screen.

### Training Process Flow

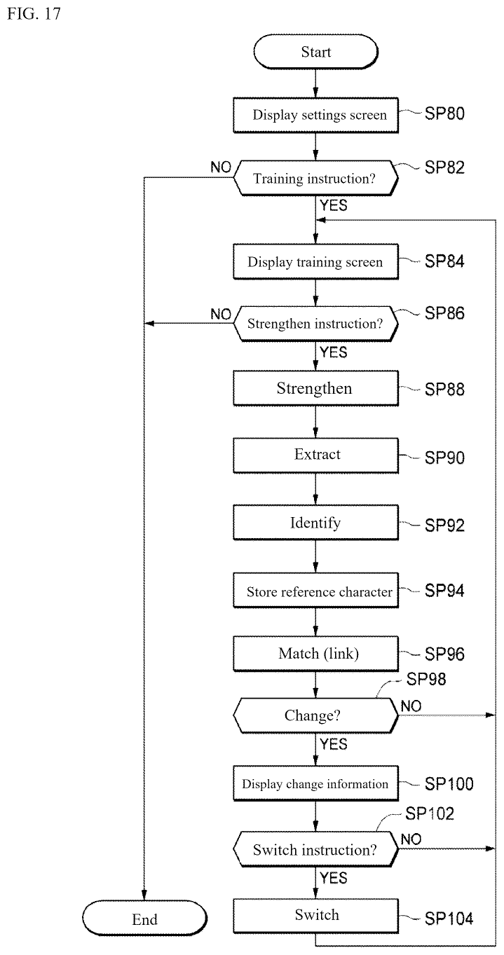

FIG. 17 is a flowchart illustrating an example of the process flow of training a reference character from the setting screen in the game system 1 according to the fourth embodiment. The process of the following steps is also initiated when the player selects the Setting tab in the character menu. The order and content of the following steps may be changed as appropriate.

### Step SP80

The control unit 58 causes the touch panel 32 to display a setting screen for setting a set character.

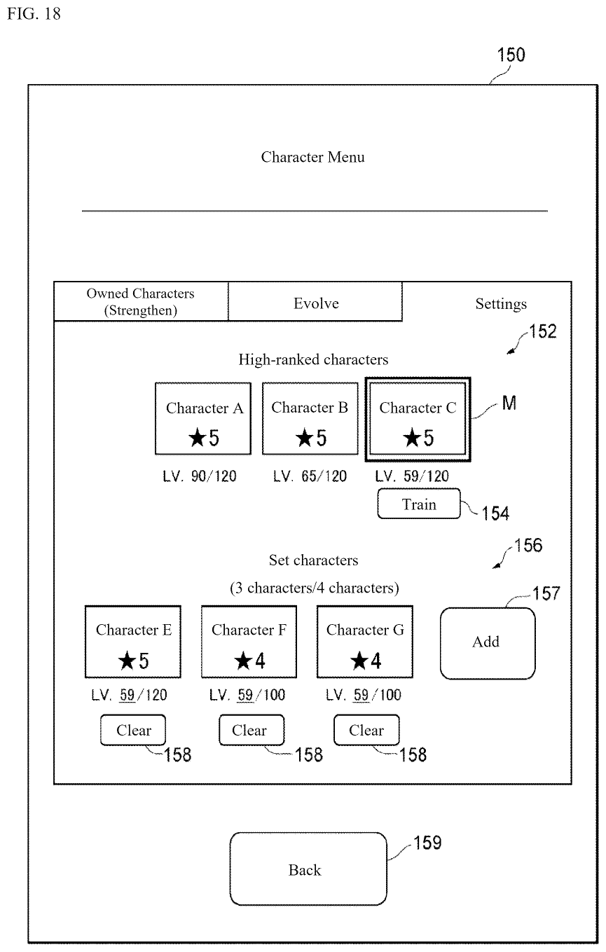

FIG. 18 illustrates an example of a setting screen 150 for set character.

As illustrated in FIG. 18, the setting screen 150 is provided with a high-ranking character information area 152, a training button 154, a set character information area 156, an add button 157, a cancel setting button 158, and a back button 159.

The high-ranking character information area 152 displays images of characters (high-ranking characters) owned by the player that have the highest (first to third) predetermined parameters (levels), including the reference character, as well as the predetermined parameters (levels) of each of the high-ranking characters. Moreover, a mark M is attached to the reference character.

The training button 154 is a designation area for increasing a predetermined parameter of a reference character. For example, the training button 154 is a button for designating a reference character as a training character and issuing an instruction to move to a training screen on which it is possible to increase a predetermined parameter.

The set character information area 156 displays an image of a character that the player has set as a set character from among the characters owned by the player, as well as predetermined parameters of the set character that are made to match those of a reference character. Furthermore, the number of characters set by the player and the number of characters that can be set are displayed in the set character information area 156. The predetermined parameters before setting each set character may be represented in the set character information area 156.

The add button 157 is a button for issuing an instruction to add a new set character from among the characters owned by the player, excluding high-ranking characters.

The setting release button 158 is used to provide instructions to release the respective setting of the set characters.

The back button 159 is a button for issuing an instruction to return (transition) from the character menu to the main menu screen.

Returning to FIG. 17, the process moves to step SP82.

### Step SP82

The control unit 58 determines whether a training instruction has been issued by the player. For example, the control unit 58 determines whether the training button is pressed on the setting screen. If the determination is positive, the process moves to step SP84. Conversely, if the determination is negative (for example, when the back button is pressed), the process ends the series of processes illustrated in FIG. 17.

### Step SP84 to Step SP104

The process in step SP84 to step SP104 is similar to the process in step SP10 to step SP30 described above, and therefore description thereof will be omitted.

### Technical Effect

As described above, in the fourth embodiment, a computer is caused to function as the extraction unit 52 for extracting a predetermined number of owned contents in descending order of predetermined parameters, the specification unit 54 for designating, from the extracted content, the content with the lowest predetermined parameter as reference content, the setting unit 56 for setting some or all of the owned content not extracted as set content, and the control unit 58 for matching the predetermined parameters of each of the set content with the predetermined parameters of the reference content, and the control unit 58 provides a designation area for increasing a predetermined parameter of the reference content on a setting screen where the player sets the set content.

According to this configuration, the setting screen for the set content has an instruction area for increasing a predetermined parameter of the reference content, and thus the effort required by the player to train the reference content can be reduced.

In the fourth embodiment, the control unit 58, based on the fact that the reference content has been changed to other content due to an increase in a predetermined parameter of the reference content, displays change information indicating such change.

According to this configuration, change information is displayed on the setting screen based on the fact that the reference content has been changed to other content, and thus the player can easily recognize the reference content that serves as the reference for the predetermined parameter.

Furthermore, in the fourth embodiment, the change information includes the name or image of other content that has been changed.

According to this configuration, the name or image of other content that has been changed is included in the change information, making it easier for the player to recognize the reference content as the basis for a given parameter.

In the fourth embodiment, the change information includes the predetermined parameters of other content that has been changed.

According to this configuration, since the predetermined parameters of other content that has been changed are included in the change information, players can easily recognize the predetermined parameters of the reference content that is the basis for the predetermined parameters.

Also, in the fourth embodiment, the control unit 58 consumes the cost associated with the player when increasing the predetermined parameter of the reference content.

According to this configuration, when a player wants to spend money to train the standard content, the time and effort required to train the content can be reduced, thereby preventing the player's motivation for the game from declining.

Also, in the fourth embodiment, the control unit 58 does not consume any cost in matching the predetermined parameters of the configuration content with the predetermined parameters of the reference content.

According to this configuration, the player can reduce the time and effort to obtain the cost to train the set content, thereby motivating the player to play the game.

### EXAMPLES

It should be noted that the present invention is not limited to the above specific examples. In other words, even were a person skilled in the art to make appropriate design modifications to the above specific examples, these are included within the scope of the present invention insofar as they have the characteristics of the present invention. Furthermore, the elements of the embodiment described above and the modified examples described below can be combined to the extent technically possible, and combinations of these are also included within the scope of the present invention insofar as they include the features of the present invention.

For example, in the first embodiment, the control unit 58 is described as matching the predetermined parameters of each set character with the predetermined parameters of the reference character when the predetermined parameters of the training character increase, but this is not limited to this. For example, the timing for matching the specified parameters may be at regular intervals, when the player logs in, before the character menu (owned character list screen, the setting screen, or the like) is displayed, before a quest is performed, when the player acquires (owns) a character, when an owned character is sold (released), when an owned character is consumed as a material character, and the like.

Furthermore, in the first embodiment, the control unit 58 is described as displaying the change information when a predetermined parameter of the training character increases, but the change information may also be displayed when the player acquires (owns) a character, when an owned character is sold (released), when an owned character is consumed as a material character, or the like.

Furthermore, in the first embodiment, the training game has been described as a case in which predetermined material content is consumed for each of the predetermined parameters of the training character as the first character synthesis, but the first character synthesis may also consume material content selected by the player as desired. For example, the first character composition is Alternatively, the player may select, as desired, a training character from among the owned characters and a material content to be consumed, and combine the selected training character to strengthen the

Furthermore, in the first embodiment, the control unit 58 is described as increasing a predetermined parameter of a training character on the training screen, but such may decrease the predetermined parameter. For example, in a case where the lower the value of a predetermined parameter, the more advantageously the game can be played, the control unit 58 may decrease the predetermined parameter on the training screen. Examples of the predetermined parameters include the number of turns required to activate a skill, the cost value required to organize owned characters into a deck (party), and the like. In this case, the reference character may be a player-owned character with a predetermined rank from the bottom (for example, third) in terms of a predetermined parameter.

Furthermore, in the first embodiment, the control unit 58 does not consume the cost (material content) associated with the player when matching the predetermined parameters of the set character with the predetermined parameters of the reference character, but the cost may be consumed. This cost may also be over time.

Furthermore, in the first embodiment, the set characters are described as being, for example, one or more characters that are pre-set (selected) by the player from among the characters owned by the player, but the set characters may be automatically set regardless of the player's selection. For example, the setting unit 56 may automatically set a predetermined number (up to a settable number) of owned characters that have not been extracted by the extraction unit 52. For example, the setting unit 56 gives priority to characters with high rarity or characters with low predetermined parameters (levels).

In the first embodiment, a case has been described in which a reference character is designated as a training character on the training screen of FIG. 6, but a character other than the reference character may also be designated. Here, when a character whose predetermined parameter is ranked fifth from the top is trained, and the predetermined parameter of the character becomes the reference character (ranked third from the top), the control unit 58 displays the change information.

Furthermore, this change information only needs to have a change information area indicating that the training character has become the reference character, and there is no need to have a query information area or a switching button.

Furthermore, in the fourth embodiment, the control unit 58 is described as displaying an instruction area (training button) on the setting screen for increasing a predetermined parameter of a reference character, but the instruction area may also be an image showing a character (reference character). The setting screen may also be provided with an instruction area for increasing a predetermined parameter of each high-ranking character. The setting screen may also be provided with an instruction area for clearing the setting of each set character and moving the character whose setting has been cleared to the training screen as a training character.

In the first to fourth embodiments, the reference character is one character (single), but the reference character may be a plurality of characters. For example, when there are multiple characters with the lowest predetermined parameters (for example, levels) among the predetermined number of characters (higher order characters) extracted by the extraction unit 52, the identification unit 54 identifies the multiple characters as reference characters. In this case, the control unit 58 may train (increase predetermined parameters) a plurality of reference characters collectively on the training screen or setting screen. For example, the training screen or the setting screen may display an image showing each of a plurality of reference characters, and a button for collectively increasing a predetermined parameter of each of the plurality of reference characters. For example, when a reference character is changed to another character due to a simultaneous increase in the respective predetermined parameters of a plurality of reference characters, the control unit 58 displays change information including an image showing the other character. The other character may be multiple characters.

Furthermore, in the first embodiment to fourth embodiments, the predetermined parameter is described mainly as a level, but it may also be luck, a level limit, a skill level, rarity, hit points, attack power, defense power, or the like.

Furthermore, in the first to fourth embodiments, a character is mainly used as an example of content, but the content may be a weapon item, an armor item, a card, an avatar, a costume, or the like.

In the above embodiments, a memory or a storage device is described as a recording medium, but the recording medium is not limited to a memory or a storage device. The recording medium may be, for example, a storage device such as a hard disk drive (HDD: Hard Disk Drive) or solid state drive (SSD: Solid State Drive) built into a computer system, a magneto-optical disk, a ROM (Read Only Memory), a CD (Compact Disc)-ROM, or a portable medium such as a flash memory.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

### DESCRIPTION OF REFERENCE NUMERALS

10 . . . server device 12 . . . terminal device 50 . . . storage unit 52 . . . extraction unit 54 . . . identification unit 56 . . . setting unit 58 . . . control unit

What is claimed is:

1. A computer-readable non-transitory recording medium recording instructions for assisting a player to train a game content, the instructions causing a computer to execute:
in response to an input by a player via a terminal device, setting, as a training game content from among player's owned game contents, an owned game content that has been designated by the player;
causing the terminal device to display a training screen including an image showing the training game content;
in response to a player request to train the training game content input via the training screen, increasing a predetermined parameter of the training game for training the game content;
extracting, from among the owned game contents including the training game content, a predetermined number of owned game contents in descending order of a predetermined parameter of the owned game contents for training the game content;
identifying, as a reference game content from among the owned game contents that have been extracted, the game content having a lowest predetermined parameter;
setting, as a set game content, some or all of the owned game contents that have not been extracted;
matching the predetermined parameter of the set game content with the predetermined parameter of the reference game content; and
in response to the reference game content being changed to another game content in association with an increase in the predetermined parameter of the owned game content, displaying change information indicating that the reference game content has been changed to the other game content different from the reference game content that has been changed.

2. The recording medium according to claim 1, wherein the change information includes a name or an image of the other game content different from the reference game content that has been changed.

3. The recording medium according to claim 2, wherein the change information includes the predetermined parameter of the other game content different from the reference game content that has been changed.

4. The recording medium according to claim 1, wherein
when the predetermined parameter of the reference game content is increased, as the training game content, the change information includes a query as to whether to switch the training game content to the other game content different from the reference game content that has been changed; and
the instructions further cause the computer to execute:
in response to receiving a player request from the terminal device, switching the training game content to the other game content different from the reference game content that has been changed.

5. The recording medium according to claim 1, wherein when the predetermined parameter of the reference game content is increased, as the training game content, the change information indicates that the training game content is changed to the other game content different from the reference game content that has been changed.

6. The recording medium according to claim 1, wherein
the instructions further cause the computer to execute:
consuming a cost associated with the player when increasing the predetermined parameter of the training game content.

7. The recording medium according to claim 6, wherein
the instructions further cause the computer to execute:
refraining from consuming the cost when matching the predetermined parameter of the set game content with the predetermined parameter of the reference game content.

8. An information processing device that assists a player to train a game content, comprising:
a hardware processor that:
in response to an input by a player via a terminal device, sets, as a training game content from among player's owned game contents, an owned game content that has been designated by the player,
causes the terminal device to display a training screen including an image showing the training game content,
in response to a player request to train the training game content input via the training screen, increases a predetermined parameter of the training game for training the game content,
extracts, from among the owned game contents including the training game content, a predetermined number of owned game contents in descending order of a predetermined parameter of the owned game contents for training the game content,
identifies, as a reference game content from among the owned game contents that have been extracted, the game content having a lowest predetermined parameter,
sets, as a set game content, some or all of the owned game contents that have not been extracted,
matches the predetermined parameter of the set game content with the predetermined parameter of the reference game content, and
in response to the reference game content being changed to another game content in association with an increase in the predetermined parameter of the owned game content, displays change information indicating that the reference game content has been changed to the other game content.
